(19) United States
(12) Patent Application Publication
(10) Pub. No.: US 2002/0040323 A1
(43) Pub. Date: Apr. 4, 2002

(54) Method and system for distributing electronic files on a network

(76) Inventors: Hsin-Chin Lee, Taipei (TW); Kuang-Rong Lu, Kaohsiung (TW); Tung-Shou Chen, Taichung (TW); Kuo-Wei Liu, Taipei (TW)

Correspondence Address: BIRCH STEWART KOLASCH & BIRCH, PO BOX 747, FALLS CHURCH, VA, 22040-0747, US

(21) Appl. No.: 09/726,332

(22) Filed: Dec. 1, 2000

(30) Foreign Application Priority Data
Sep. 21, 2000 (TW) 89119491

(51) Int. Cl. G06F 17/60

(52) U.S. Cl. 705/26

(57) ABSTRACT

A method for distributing electronic files over a network comprising a file combination procedure, a combined electronic file providing procedure, a payment receiving procedure and a main electronic file providing procedure. The file combination procedure combines a main electronic file and an accompanying electronic file into a combined electronic file. The combined electronic file providing procedure provides the combined electronic file to a user before the payment receiving procedure. The payment receiving procedure is a payment procedure that receives the payment from the user for the purchase of the main electronic file. The main electronic file providing procedure provides the user the main electronic file and adds in the main electronic file a watermark for identifying the user. The invention also discloses a corresponding system of distributing electronic files over a network.

### BACKGROUND OF THE INVENTION

1. Field of Invention

The invention relates to a method of distributing electronic files on a network and the system of the same.

2. Related Art

As information technology grows, electronic files such as MP3 files, shareware, electronic books or information databases have become a new type of merchandise. Distributing, searching for or selling electronic files via a network has also become a new type of merchandise marketing model.

In general, the model of electronic file marketing on a network is to charge a user monthly, annually or by the times the user downloads the electronic file. However, due to security concerns regarding data transmission over the network and the fact that normal network users are used to downloading free electronic files from the network, users are less willing to pay for electronic files.

Currently, some electronic file suppliers allow users to freely download electronic files. The users, nevertheless, have to accept the accompanying advertisements too. For example, a user can freely download MP3 files from the network, but he has to watch the accompanying advertisements while playing the MP3 files. Only after the user pays to purchase the downloaded electronic files will the electronic file supplier remove the accompanying advertisements. This is a compromised solution, yet it has the following problems:

First, the electronic file supplier cannot stop users from further distributing paid electronic files. After the user pays to purchase the downloaded electronic files, he can arbitrarily send the files to his relatives and friends or even put them on the network for others to download. This will result in financial losses for the electronic file supplier.

Secondly, when the advertisements provided by the electronic file supplier are irrelevant to the content of the download files, the advertising has little effect. This is because the user is not interested in the accompanying advertisements at all and may dislike the advertisements, thus diminishing the effectiveness of the advertisement.

Furthermore, the usual advertisement accounting method relies on the electronic file supplier or the advertisement supplier counting the number of times an advertisement is clicked on by the user to determine the amount the electronic file supplier earns. However, this method cannot directly tell how many times an electronic file has been used. That is, if the file attached to the electronic file is not a clickable advertisement but some information relevant to the electronic file, the electronic file provider cannot know how popular the electronic file itself is.

Therefore, how to provide a method and the corresponding system of distributing electronic files on a network that can prohibit users from arbitrarily distributing paid electronic files, attract users to watch the attached files and at the same time determine how popular the electronic file itself is by counting its use times is an urgent subject to be solved.

### SUMMARY OF THE INVENTION

In view of the foregoing, it is an objective of the invention to provide a method and the corresponding system of distributing electronic files on a network that can prohibit users from arbitrarily distributing paid electronic files.

It is another objective of the invention to provide a method and the corresponding system of distributing electronic files on a network that can count the number of times an electronic file is used before it is paid for so as to increase the advertising effect of the attached files.

To achieve the above objectives, the disclosed method of distributing electronic files on a network includes a file combination procedure, a combined electronic file providing procedure, a payment receiving procedure and a main electronic file providing procedure. The file combination procedure combines a main electronic file and an accompanying electronic file into a combined electronic file. The combined electronic file providing procedure provides the combine electronic file to a user before the payment receiving procedure. The payment receiving procedure receives the user's payment for the purchase of the main electronic file. The main electronic file providing procedure provides the user the main electronic file and adds therein a watermark identifying the user after the payment receiving procedure is completed.

The invention also discloses a system of distributing electronic files on a network, which includes a file combination module and a file providing module. The file combination module combines a main electronic file and an accompanying electronic file into a combined electronic file. The file providing module provides the combined electronic file to a user before the user pays for the main electronic file, while provides the main electronic file to the user and adds therein a watermark identifying the user after the user pays for the main electronic file.

Other features and advantages of the invention will be apparent from the following detailed description, which proceeds with reference to the accompanying drawings.

### BRIEF DESCRIPTION OF THE DRAWINGS

FIG. 1(A) is a flow chart of the method of distributing electronic files on a network according to a preferred embodiment of the invention.

FIG. 1(B) is another flow chart of the method of distributing electronic files on a network according to a preferred embodiment of the invention.

FIG. 2 schematically illustrates a system of distributing electronic files on a network according to a preferred embodiment of the invention.

In the various drawings, the same references relate to the same elements.

### DETAILED DESCRIPTION OF THE INVENTION

The method and system of distributing electronic files on a network according to a preferred embodiment of the invention will be apparent from the following detailed description, which proceeds with reference to the accompanying drawings, wherein the same references relate to the same elements.

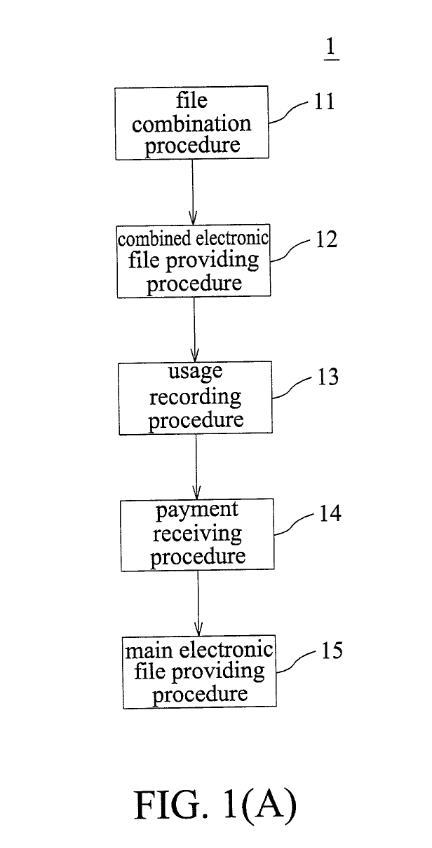

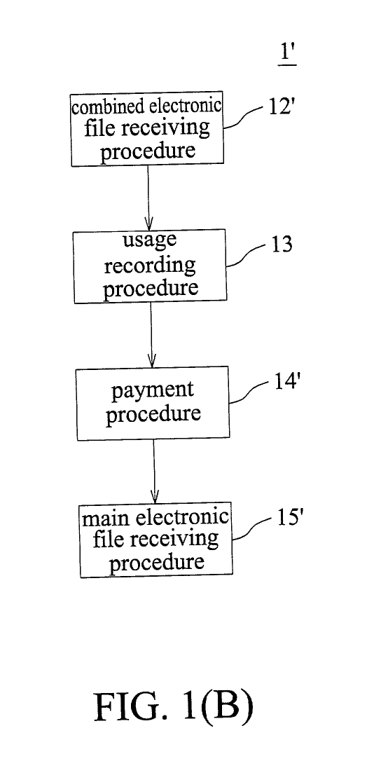

Referring to FIG. 1(A), the method of distributing electronic files on a network 1 according to a preferred embodiment of the invention first performs a file combination procedure 11 to combine a main electronic file and an accompanying file into a combined electronic file and stores the combined electronic file in a file server. In the current embodiment, the main electronic file refers to an MP3 file and the accompanying file is a file in the Flash format. The combined electronic file is one obtained by inserting the MP3 file into the Flash formatted file. Since the Flash formatted file can store such things as MP3 files, vector animations, texts, images, drawings and interactive commands, using it to embed the main electronic file achieves the objective of the invention. The contents of the accompanying electronic file can be designed according to the MP3 file, e.g., introductions of singers, songs, record companies, other related songs or albums. The above contents can appear at the same time or in turns to enhance the attractiveness of the accompanying electronic file for the user. In addition, the contents of the accompanying file can include various hyperlinks. In this way, the user can actively visit websites on the network by clicking the hyperlinks and the accompanying electronic file provider can provide relevant information to the user through the hyperlinks.

Afterwards, in a combined electronic file providing procedure 12 the file server allows users to freely download the combined electronic file. After the user downloads the combined electronic file, he can arbitrarily distribute the combined electronic file. Before the user pays for the MP3 file in the combined electronic file, the user can only listen to the music contained in the MP3 file through the combined electronic file. When using the combined electronic file, the user will listen the music generated from the main electronic file (i.e., the MP3 file) and watch the animation or text content generated by the accompanying electronic file (i.e., the Flash file).

When the user uses the combined electronic file to listen to the music in the MP3 file, a usage recording procedure 13 can record the times the user uses the combined electronic file. By counting the number of times a particular combined electronic file is used, one can infer the popularity of the MP3 file contained therein.

When the user wants to pay for the MP3 file, a payment receiving procedure 14 is performed receive the user's payment for the MP3 file. As to the payment method for the MP3 file, there are currently many payment mechanisms existing on the network, e.g., payment by credit cards or electronic purses, and therefore are not further described herein.

After the user pays for the purchase, the procedure enters a main electronic file providing procedure 15 to provide the user the paid main electronic file. For example, after the user pays for the MP3 file, an MP3 file that does not contain an accompanying file is sent to the user. At the same moment, the main electronic file providing procedure 15 will add a watermark in the MP3 file in order to identify the owner of the MP3 file. This can prohibit the user from arbitrarily sending the paid MP3 file to other users. There are currently several optional technologies for adding watermarks to an electronic file and they are not further described herein.

With reference to FIG. 1(B), the method of distributing electronic files on a network 1′ according to another preferred embodiment of the invention comprises a combined electronic file receiving procedure 12′, a usage recording procedure 13, a payment procedure 14′ and a main electronic file receiving procedure 15′. The combined electronic file receiving procedure 12′ corresponds to the previously mentioned combined electronic file providing procedure 12, the payment procedure 14′ to the previously mentioned payment receiving procedure 14, and the main electronic file receiving procedure 15′ to the main electronic file providing procedure 15. In other words, the difference between the method 1′ shown in FIG. 1(B) and the method 1 shown in FIG. 1(A) is in that FIG. 1(A) takes the viewpoint of a server while FIG. 1(B) the viewpoint of a user.

In the combined electronic file receiving procedure 12′, the user receives a combined electronic file containing a main electronic file and an accompanying electronic file. In the current embodiment, as in the previous embodiment, the main electronic file refers to an MP3 file, the accompanying electronic file is a Flash formatted file and the combined electronic file is one obtained by embedding the MP3 file into the Flash formatted file.

When the user wants to pay for a particular MP3 file, the payment procedure 14′ is marked charged for that particular MP3 file. The user then receives the MP3 file he has paid for in the main electronic file receiving procedure 15′. As described hereinbefore, the paid MP3 file has a watermark for identifying the user, which prohibits the user from distributing the paid MP3 file.

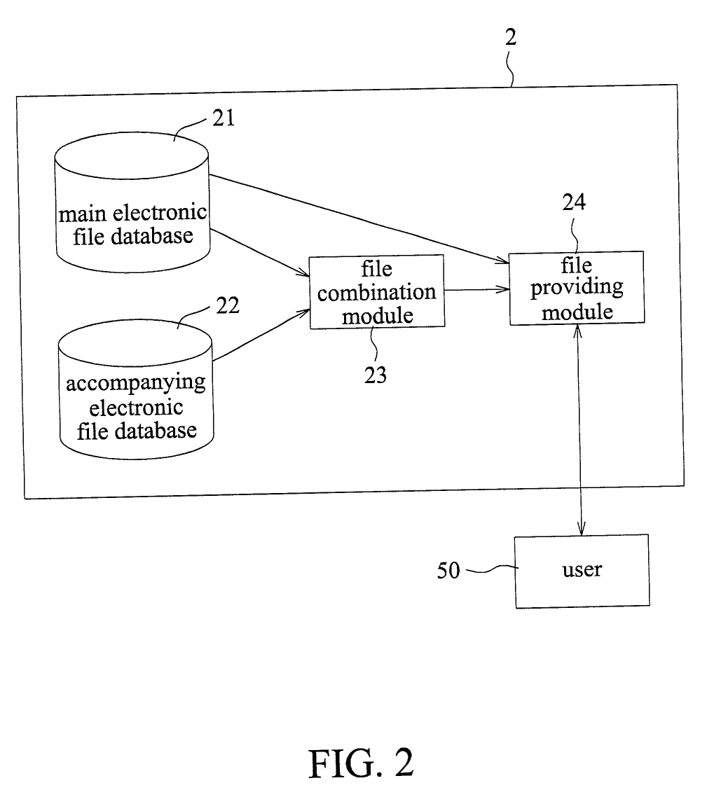

Referring to FIG. 2, the system of distributing electronic files on a network 2 according to a preferred embodiment of the invention comprises a main electronic file database 21, an accompanying electronic file database 22, a file combination module 23 and a file providing module 24.

The main electronic file database 21 stores at least one main electronic file. In addition, the main electronic file database 21 can also store the usage times of each main electronic file and the payment times by the user. The merchant can determine the acceptance of different main electronic files by users from these data.

The accompanying electronic file database 22 stores at least one accompanying electronic file. As described hereinbefore, when the main electronic file is an MP3 file, the accompanying file can have content designed particularly for the MP3 file, e.g., introductions of singers, songs, lyrics, record companies, other related songs or albums.

The file combination module 23 combines the main electronic file and the accompanying electronic file according to the contents of the main electronic file. As described hereinbefore, if the main electronic file is an MP3 file, the accompanying electronic file can be a Flash formatted file.

The function of the file providing module 24 is to provide a combined electronic file to a user before the user pays for the main electronic file. After the user pays for the main electronic file, the module 24 provides the main electronic file to the user and adds therein a watermark that can identify the user. This part is essentially the same as the one for the distribution method of electronic files on a network described hereinbefore and therefore is not repeated herein.

The system 2 can be implemented by using a network server or several coupled servers. For example, the main electronic file database 21 and the accompanying electronic file database 22 can be stored in one database server, and the functions of the file combination module 23 and the file providing module 24 are achieved using another network server.

According to the invention, the method and system of distributing electronic files on a network provide the combined electronic file before a user pays for it and provides the main electronic file only after the user pays. Therefore, they can effectively distribute electronic files over the network, simultaneously achieving the effects of making a profit and advertising.

The method and system of distributing electronic files on a network of the invention add a watermark onto the main electronic file being sent to the paying user; thus, they can prohibit the user from arbitrarily distributing the paid main electronic file.

The method and system of distributing electronic files on a network according to the invention can count the usage times of an electronic file before it is paid so as to correctly determine the popularity thereof.

The method and system of distributing electronic files on a network according to the invention can provide accompanying electronic files attractive to users, thus greatly increasing the effectiveness of the advertising on the accompanying electronic files.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of distributing electronic files on a network, which comprises:
a file combinations procedure, which combines a main electronic file and an accompanying electronic file into a combined electronic file;
a combined electronic file providing procedure, which provides the combined electronic file to a user before the user pays for the main electronic file;
a payment receiving procedure, which receives the payment made by the user for the purchase of the main electronic file; and
a main electronic file providing procedure, which provides the main electronic file to the user and adds therein a watermark that can identify the user after the payment receiving procedure.

2. The method of claim 1 further comprising a use recording procedure, which records the number of times the user has used the combined electronic file.

3. The method of claim 1, wherein the main electronic file providing procedure provides the main electronic file to the user by removing the accompanying electronic file from the combined electronic file.

4. The method of claim 1, wherein the main electronic file providing procedure provides the main electronic file to the user by sending the main electronic file solely and directly to the user.

5. The method of claim 1, wherein the main electronic file is an MP3 file.

6. The method of claim 1, wherein the accompanying electronic file is a Flash formatted file.

7. The method of claim 1, wherein the accompanying electronic file includes hyperlinks.

8. A method of distributing electronic files on a network, which comprises:
a combined electronic file receiving procedure, which receives a combined electronic file containing a main electronic file and an accompanying electronic file before a user pays for the main electronic file;
a payment procedure, which perform the payment procedure of purchasing the main electronic file; and
a main electronic file receiving procedure, which receives the main electronic file and adds therein a watermark that can identify the user after the payment procedure.

9. The method of claim 8 further comprising a usage recording procedure, which records the number of times the combined electronic file has been used.

10. The method of claim 8, wherein the main electronic file is an MP3 file.

11. The method of claim 8, wherein the accompanying electronic file is a Flash formatted file.

12. The method of claim 8, wherein the accompanying electronic file includes hyperlinks.

13. A system of distributing electronic files on a network, which comprises:
a file combination module, which combines a main electronic file and an accompanying electronic file into a combined electronic file; and
a file providing module, which provides the combined electronic file to a user before the user pays for the main electronic file while providing the main electronic file to the user and adds therein a watermark that can identify the user after the user pays for it.

14. The system of claim 13 further comprising a main electronic file database that stores at least one main electronic file.

15. The system of claim 14, wherein the main electronic file database further stores the number of times each of the main electronic file has been used.

16. The system of claim 13 further comprising an accompanying electronic file database that stores at least one accompanying electronic file.

17. The system of claim 13, wherein the main electronic file is an MP3 file.

18. The system of claim 13, wherein the accompanying electronic file is a Flash formatted file.

19. The system of claim 13, wherein the accompanying electronic file includes hyperlinks.
